(19) United States
(12) Patent Application Publication
(10) Pub. No.: US 2008/0008448 A1
(43) Pub. Date: Jan. 10, 2008

(54) METHOD AND APPARATUS FOR CONTROLLING REPRODUCTION OF A TITLE INCLUDING AV DATA AND INFORMATION RECORDING MEDIUM

(75) Inventors: Man-seok Kang, Suwon-si (KR); Sung-wook Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/690,972

(22) Filed: Mar. 26, 2007

(30) Foreign Application Priority Data
Jun. 30, 2006 (KR) 2006-60689

(51) Int. Cl. H04N 7/00

(52) U.S. Cl. 386/95

(57) ABSTRACT

A method and apparatus for controlling reproduction of a title including AV data and an information recording medium are provided. The method of controlling reproduction of a title comprising AV data, where the title is recorded in an information recording medium, includes controlling playback of a previous title, which has been reproduced before a title being currently reproduced, by referring to information about a command, which is to be executed after resuming at the previous title, when resuming at the previous title. Using the method, a location for resuming can be exactly appointed while transferring and resuming playback between a plurality of titles.

### CROSS-REFERENCE TO RELATED APPLICATIONS

This application claims the benefit of Korean Patent Application No. 2006-60689, filed on Jun. 30, 2006, in the Korean Intellectual Property Office, the disclosure of which is incorporated herein by reference.

### BACKGROUND OF THE INVENTION

1. Field of the Invention

Aspects of the present invention relate to a method and apparatus for controlling reproduction of a title including AV data and an information recording medium.

2. Description of the Related Art

FIG. 1 is a diagram illustrating data recorded in a conventional information recording medium for reproducing AV data. In FIG. 1, title information 110 is the highest level of classification for data recorded in the information recording medium. The title information 110 contains information about a menu and each title.

A command set 120 includes commands to control playback of each title. When a certain title is selected, a command corresponding to the certain title is executed in order to control playback of the certain title. The command set 120 includes a Command List #1 121, a Command List #2 122, and so on, up to a Command List #m 123. Each of the command lists #1 121 to #m 123 includes commands for reproducing AV data. When AV data that is to be reproduced is selected, an apparatus to control reproduction of the AV data reproduces the selected AV data. Command List #1 121 selects a PlayList #x 130. The PlayList #x 130 includes a PlayItem #0 131 through a PlayItem #n 132. The PlayItem #0 131 defines an AV stream #i 141 and the PlayItem #n 132 defines an AV stream #j 142.

The apparatus to control reproduction of an image using the conventional image storage medium receives title information from the information recording medium through a playback control unit and selects a title that is set to be initially reproduced or selects a title that a user wants to reproduce. The selected title executes a command list using command information recorded with commands to control the reproduction of an image. The commands in the command list are sequentially executed starting with a first command by the playback control unit. When a command related to playback is executed, a PlayList that is to be reproduced is selected. Playback starts from the first PlayItem included in the selected PlayList, or from a beginning or a predetermined location of presentation data connected to a predetermined PlayList. When processing of the predetermined presentation data is over, the next command in the list is executed.

Using the above processes, reproduction of the presentation data can be controlled while reproducing the presentation data by using the above processes, when the playback of the title being reproduced is stopped by a user or by command information and playback is transferred to other presentation data of a different title or of the same title. Resuming at the previous presentation data of the previous title or at the same title is possible while reproducing other presentation data. To accomplish this, the apparatus for controlling reproduction of a title uses a title resumption information register.

When the playback location of the title or the presentation data is transferred by the user, or the command information to control playback while the presentation data that is to be reproduced has been selected and is being reproduced, the playback control unit determines whether to record playback location information of the current title being reproduced. When the playback location information of the current title should be recorded, the playback control unit records the value of a title playback information register in the title resumption information register. For example, a title jump command does not record title resumption information for resuming at the current playback location and deletes the title resumption information when the title resumption information is already recorded in the title resumption information register. A title call command, on the other hand, does record title playback information in the title resumption information register for resuming at the current playback location. When the playback location of the title or the presentation data is transferred after the playback location information of the title or the presentation data being reproduced has been recorded, the playback location can resume at the previous title or presentation data by the user or the command information while reproducing the transferred title or the transferred representation data or after completing the playback of the transferred title or the transferred representation data. Accordingly, the apparatus to control reproduction stops processing the presentation data and transfers the title resumption information recorded in the title resumption information register and records the title resumption information in the title playback information register. Thus, the title playback information of the previous title is recovered and the presentation data is processed according to the recovered title playback information.

FIG. 2 is a diagram illustrating a conventional example of a command set included in a title and data reproduced in order to execute the command set. A Title #1 includes a Command List #1 210. When the Command List #210 is executed, a first command, i.e., Play PlayList #1 220, is executed in order to reproduce PlayList #1 220. When a user starts the Call Title #2 240 operation while reproducing an AV stream #0 230 included in the PlayList #1 220, playback information of the Title #1, which is being reproduced, is recorded in a title resumption information register. Playback information includes title number, chapter number, PlayList number, PlayItem number, and presentation time. Playback of video then stops and transfers to Title #2. In order to reproduce Title #2, a Command List #2 250 of the Title #2 is executed. Accordingly, a first command on the Command List #2 250, i.e., Play PlayList #3, is executed in order to reproduce an AV stream #2 270 included in a PlayList #3 260. When playback of the AV stream #2 270 completes, a second command on the Command List #2 250, i.e., Resume, is executed in order to re-record the title playback information of the previous title, which is recorded in the title resumption information register, in the title playback information register, and to re-start playback of the AV stream #0 230 from a location corresponding to the PlayList, PlayItem, and presentation time according to the title playback information of the recovered title playback information register.

When playback of the AV stream #0 230 completes, a second command of the Command List #1 210, Play PlayList #2, is supposed to be executed, but since neither a command list to be executed next nor command line information in the command list exists in the title playback information register, it is unclear which command should be executed after executing the second command in the Command List #2 250.

Accordingly, since information recorded in the title resumption information register does not include information on commands, the first command or a wrong command might be executed after resuming at the title, which was being reproduced previously, using the title resumption information and completing the playback of all the presentation data, because a control command from the command list, which should be executed for the next playback, cannot be found.

### SUMMARY OF THE INVENTION

Aspects of the present invention provides a method and apparatus to control reproduction of a title including AV data, which can appoint an exact resumption location while transferring or resuming playback between a plurality of titles.

Aspects of the present invention also provides a method and apparatus to control reproduction of a title in which complex title transference is possible by a content producer appointing a value to a title resumption information register.

According to an aspect of the present invention, there is provided a method of controlling reproduction of a title recorded in an information recording medium and comprising AV data, the method comprising controlling playback of a previous title, which has been reproduced before a current title currently being reproduced, by referring to information about a command, which is to be executed after resuming at the previous title, when resuming at the previous title.

According to another aspect of the present invention, the information about the command may include identifier information of a command list which should be executed for the previous title.

According to another aspect of the present invention, the information about the command may further include location information of a command, which has been most recently executed from the command list, or location information of a command, which is to be executed next.

According to another aspect of the present invention, the method may further include recording the information about the command in a title playback information register when reproducing the previous title.

According to another aspect of the present invention, the method may further include recording in a title resumption information register the information about the command recorded in the title playback information register when transferring from the previous title to the current title.

According to another aspect of the present invention, the method may further include recording in the title playback information register the information about the command recorded in the title resumption information register, when resuming at the previous title after the current title has completed.

According to another aspect of the present invention, the method may further include recording the information about the command in a title resumption information register when transferring from the previous title to the current title; and executing a command for the previous title by referring to the information about the command recorded in the title resumption information register, when resuming at the previous title after the current title.

According to another aspect of the present invention, there is provided a method of controlling reproduction of a title recorded in an information recording medium and comprising AV data, the method including: arbitrarily changing title resumption information stored in a title resumption information register using a playback control command; and controlling playback of the title by referring to the changed title resumption information.

According to another aspect of the present invention, the arbitrarily changing may include recording the title resumption information, stored in the title resumption information register, in a general purpose register using a first playback control command.

According to another aspect of the present invention, the arbitrarily changing may include recording the title resumption information, stored in the general purpose register, in the title resumption information register using a second playback control command.

According to another aspect of the present invention, the arbitrarily changing may include: recording title playback information stored in a title playback information register as the title resumption information of the title resumption information register using a title call command; recording the title resumption information, stored in the title resumption information register, in a general purpose register using a resume information store command; deleting the title resumption information, stored in the title resumption information register, using a title jump command; and recording the title resumption information, stored in the general purpose register, in the title resumption information register using a resume information restore command.

According to another aspect of the present invention, there is provided an apparatus for controlling reproduction of a title, recorded in an information recording medium and comprising AV data, the apparatus including: a reader to read the title from the information recording medium; and a playback controller to control playback of a previous title by referring to information about a command which is to be executed after resuming at the previous title, when resuming at the previous title; wherein the previous title has been reproduced before a current title currently being reproduced.

According to another aspect of the present invention, the apparatus may further include a title playback information register to store title playback information, wherein the playback controller records the information about the command in the title playback information register when reproducing the previous title.

According to another aspect of the present invention, the apparatus may further include a title resumption information register which stores title resumption information, into which the playback controller records the information about the command recorded in the title playback information register when transferring from the previous title to the current title.

According to another aspect of the present invention, the playback controller may record the information about the command, recorded in the title resumption information register, in the title playback information register when resuming at the previous title after the current title has completed.

According to another aspect of the present invention, the playback controller may record the information about the command in the title resumption information register when transferring from the previous title to the current title by recalling the information about the command for title resumption, and may reproduce the previous title by referring to the information about the command recorded in the title resumption information register when resuming at the previous title after the current title.

According to another aspect of the present invention, there is provided an apparatus for controlling reproduction of a title recorded in an information recording medium and comprising AV data, the apparatus including: a title resumption information register, to store title resumption information used when resuming at a previous title after a current title; and a playback controller, to arbitrarily change the title resumption information stored in the title resumption information register using a playback control command and to control playback of the title by referring to the changed title resumption information.

According to another aspect of the present invention, there is provided an information recording medium for an apparatus for controlling reproduction of AV data, the information recording medium including: a title which includes of the AV data; and a playback control command which controls an arbitrary change of title resumption information, stored in a title resumption information register, which is used when resuming at a previous title after a current title which is being reproduced.

According to another aspect of the present invention, the playback control command may include a first playback control command which commands the title resumption information, stored in the title resumption information register, to be recorded in a general purpose register.

According to another aspect of the present invention, the playback control command may include a second playback control command which commands the title resumption information, stored in the general purpose register, to be recorded in the title resumption information register.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating data recorded in a conventional information recording medium for reproducing AV data;

FIG. 2 is a diagram illustrating a conventional example of a command set included in a title, and data reproduced in order to execute the command set;

FIG. 3 is a block diagram illustrating an apparatus for controlling reproduction of AV data in an information recording medium according to an embodiment of the present invention;

FIG. 4 is a diagram illustrating a title playback information register and a title resumption information register according to embodiments of the present invention;

FIG. 5 is a diagram illustrating an example of a command set included in a title and data reproduced in order to execute the command set according to an embodiment of the present invention;

FIG. 6 is a diagram illustrating an example of transferring and resuming playback of a title when a value of a title resumption information register can be changed by a playback control command according to an embodiment of the present invention;

FIG. 7 is a flowchart of controlling reproduction of AV data by referring to information about a command when resuming a title according to an embodiment of the present invention; and

FIG. 8 is a flowchart of controlling reproduction by changing a value of a title resumption information register according to an embodiment of the present invention.

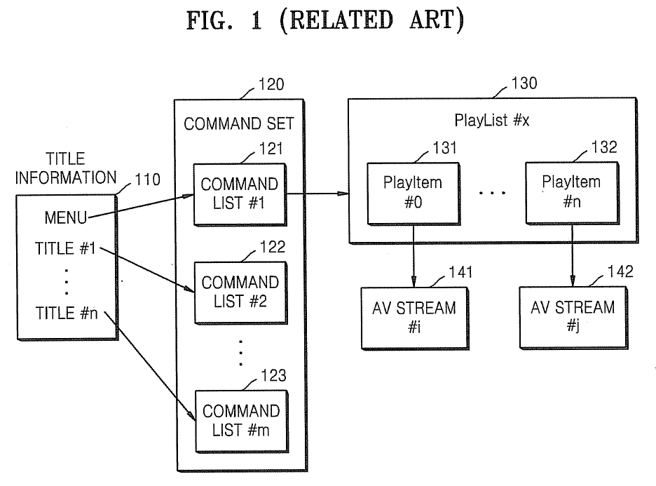

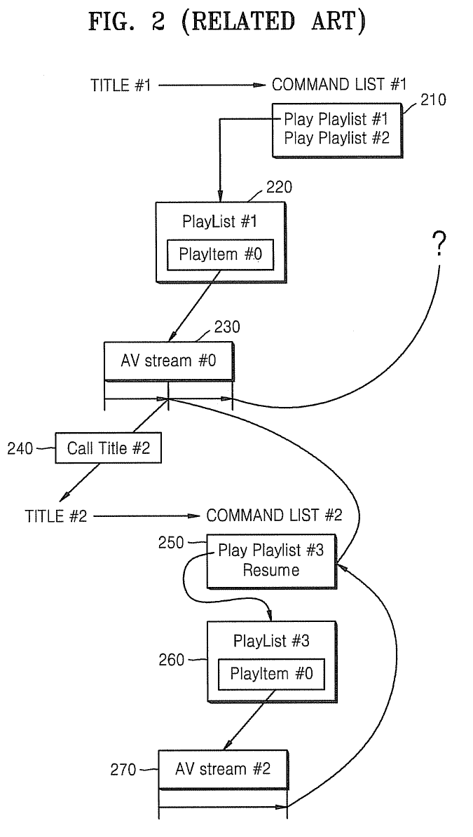

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

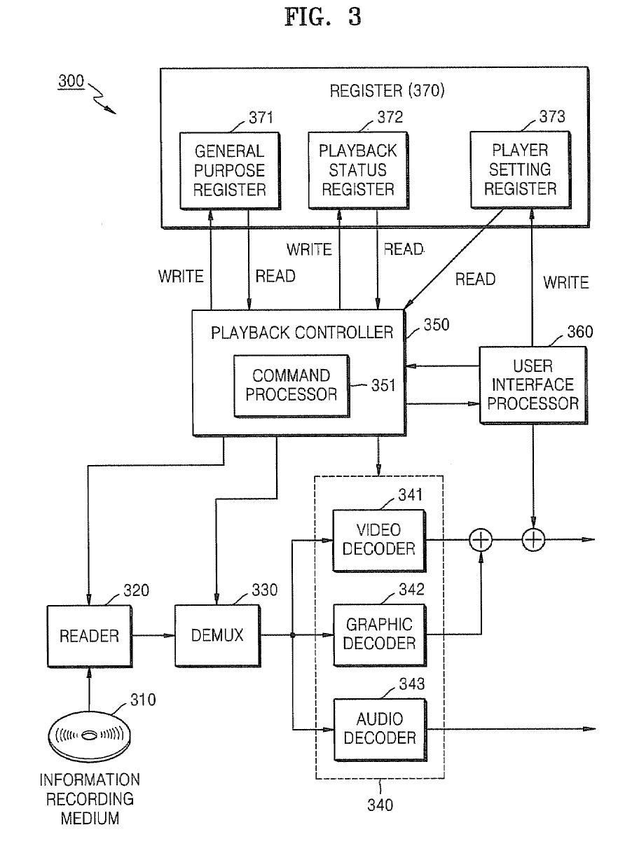

FIG. 3 is a block diagram illustrating an apparatus 300 for controlling reproduction of AV data of an information recording medium 310 according to an embodiment of the present invention. The apparatus 300 includes a reader 320 to read AV data from the information recording medium 310, a decoder 340, a demultiplexer (DEMUX) 330 to transmit the AV data received from the reader 320 to each unit of the decoder 340, a playback controller 350 including a command processor 351 to control playback of the AV data, a user interface processor 360 to provide a system menu or playback information for key input and apparatus settings, and a register 370 to store information related to the playback of the AV data.

The information recording medium 310 includes title information for reproducing the AV data, navigation command information, and playback unit information. The reader 320 receives the AV data from the information recording medium 310 as directed by the playback information. The decoder 340 includes a video decoder 341, which decodes video data received from the DEMUX 330; a graphic decoder 342, which decodes graphic data received from the DEMUX 330; and an audio decoder 343, which decodes audio data received from the DEMUX 330. The register 370 includes a general purpose register 371, a playback status register 372, and a player setting register 373. The general purpose register 371 is used in order to arbitrarily store or calculate a value using a command executed in the command processor 351 of the playback controller 350.

The player setting register 373 stores a setting status of the apparatus 300, such as age information of a user, a vocal language, a caption language, a national code, audio/video settings, or other information. The setting status cannot be changed by a command executed in the playback controller 350, but can be changed by a user interface, such as a system menu, provided by the apparatus 300.

The playback status register 372 stores playback status information, such as the title number that is being currently reproduced, a chapter number, a PlayList number, a PlayItem number, presentation time, etc., while the apparatus 300 reproduces AV data in the information recording medium 310. The playback status register 372 includes a title playback information register 410 (not shown) to store playback information of a current title being reproduced, and a title resumption information register 420 (not shown) to store title resumption information used when resuming at a previous title. The playback status register 372 can be referred to or changed using a certain playback control command while the apparatus 300 is reproducing AV data stored in the information recording medium 310.

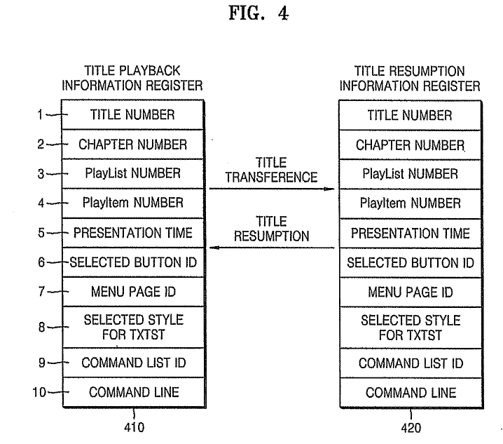

FIG. 4 is a diagram illustrating the title playback information register 410 and the title resumption information register 420 according to embodiments of the present invention. The title playback information register 410 includes a title number 1, a chapter number 2, a PlayList number 3, a PlayItem number 4, presentation time 5, a selected button ID 6, a menu page ID 7, a selected style for a text sub-title (TXTST) 8, a command list ID 9, and a command line 10. Other aspects of the present invention may use other registers.

The command list ID 9 and the command line 10 provide information about a command which is to be executed when resuming at a title previous to the current title being reproduced. The command list ID 9 represents an identifier (ID) for a command list which is to be executed. The command line 10 represents a command line which is to be executed next in the current command list.

The title playback information register 410 is formed of several registers, each storing each item, i.e. the title number 1, the chapter number 2, the PlayList number 3, etc. The title resumption information register 420 is also formed of registers, each storing a title number, a chapter number, a PlayList number, or other information. The title playback information register 410 and the title resumption information register 420 illustrated in FIG. 4 are each formed of 10 registers. Other aspects of the invention may use fewer or more registers, depending on the information to be stored.

When transferring from a first title to a second title, a value stored in the title playback information register 410 is recorded in the title resumption information register 420. When resuming at the first title after the second title, the value stored in the title resumption information register 420 is restored in the title playback information register 410.

In FIG. 4, the title playback information register 410 and the title resumption information register 420 both include a register 9 storing a command list ID and a register 10 storing a command line, but they are not limited thereto. Information about the command list ID and the command line for title resumption can be stored in the command processor 351 of FIG. 3, and only the title resumption information register 420 may include registers for the command list ID and the command line. Accordingly, when resuming a title, the command processor 351 of FIG. 3 may refer to the registers for the command list ID and the command line in the title resumption information register 420 in order to obtain information about the command to be executed next.

Operations including title transference and resumption will be described with reference to the apparatus 300 illustrated in FIG. 3. When the playback controller 350 selects a title to be reproduced by referring to the playback control information included in the information storage medium 310 or selects, through the user interface processor 360, a title that a user wants to reproduce, the command processor 351 executes a command list included in the selected title. When the command processor 351 executes a command related to playback in the command list, the playback controller 350 reproduces a PlayList directed by the command.

Specifically, the title playback information register 410 and/or the title resumption information register 420 either stores information about a command to be executed while resuming the title, or the command processor 351 remembers the information about the command to be executed while resuming the title. Accordingly, the information about the command for title resumption, stored in the tile playback information register 410, is stored in the title resumption information register 420 while transferring from the first title to the second title. The information about the command stored in the title resumption information register 420 is again stored in the title playback information register 410 when resuming at the first title after the second title. Thus, the command processor 351 can search for a command that is to be executed next in the resumed title, i.e., the first title, by referring to the information about the command stored in the title playback information register 410.

When a register for storing information about the command is included only in the title resumption information register 420, the information about the command stored in the command processor 351 can be stored in the title resumption information register 420 while transferring the title. When resuming the title, the command processor 351 may search for a command to be executed next in the resumed title by referring to the information about the command stored in the title resumption information register 420.

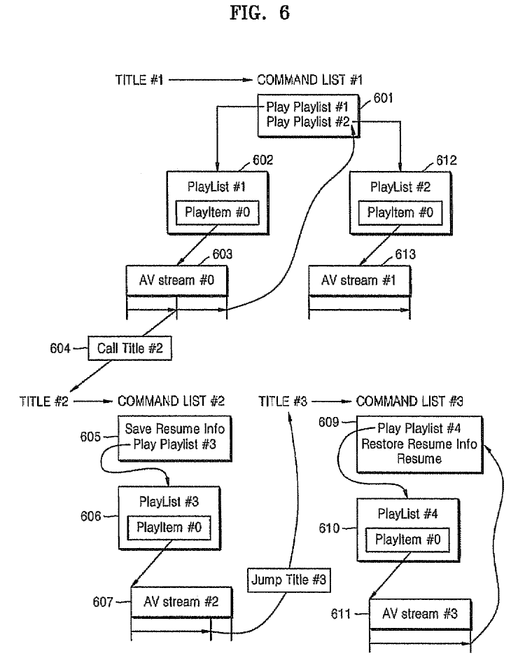

The command processor 351 may also arbitrarily change the value of the title resumption information register 420 by executing the playback control command. For example, by executing a predetermined playback control command while transferring the title, the value of the title resumption information register is temporarily stored in the general purpose register 371. Upon execution of a predetermined playback control command while resuming the title, the value temporarily stored in the general purpose register 371 is stored back in the title resumption information register 420. Operations when the value of the title resumption information register needs to be arbitrarily changed will be described later in detail with reference to FIG. 6.

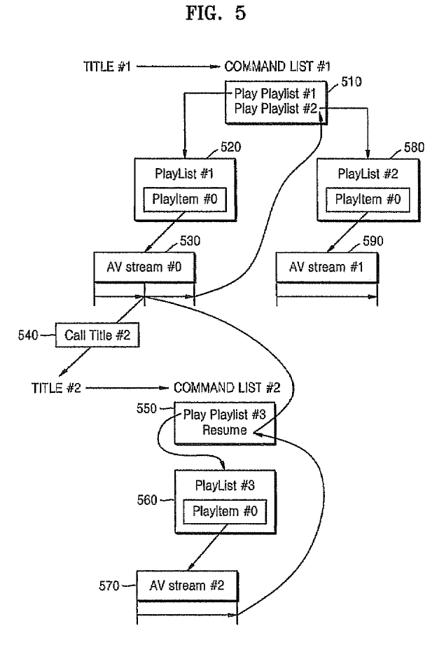

FIG. 5 is a diagram illustrating an example of a command set included in a title and data reproduced in order to execute the command set according to an embodiment of the present invention. A Title #1 includes a Command List #1 510. The command processor 351 of FIG. 3 executes a first command, i.e. Play PlayList #1 520, of the Command List #1 510 in order to reproduce PlayList #1 520, which includes PlayItem #0. When Call Title #2 540 is generated by a user while reproducing an AV stream #0 included in the PlayList #1 520, the command processor 351 of FIG. 3 records in the title resumption information register 420 playback information, stored in the title playback information register 410, of the Title #1 that is being reproduced.

After recording the playback information, command processor 351 stops reproducing AV data and transfers to a Title #2. When the apparatus executes a Command List #2 550 of the Title #2 in order to reproduce the Title #2, the command processor 351 executes a first command in the Command List #2 550, i.e., Play PlayList #3 560, in order to reproduce an AV stream #2 570 included in the PlayList #3 560. When playback of the AV stream #2 570 has completed, a second command, i.e., Resume, of the Command List #2 550 is executed. The command processor 351 re-records the title playback information of the previous title, recorded in the title resumption information register 420, in the title playback information register 410, and then starts to reproduce the AV stream #0 from a location corresponding to the PlayList, the playtime, and the presentation time according to the title playback information of the restored title playback information register 410.

When the playback of the AV stream #0 has completed, the command processor 351 may search for the command to be executed next using information about the command stored in the title playback information register 410 and the title resumption information register 420, such as the command list ID and the command line. In other words, Play PlayList #2 in a second line of the command line of the Command List #1 510 is executed in order to reproduce an AV stream #1 590 according to a PlayItem #0 in the PlayList #2 580.

Also as described above, information about the command list ID and the command line for resuming the title can be stored in the command processor 451 of FIG. 3. Registers for recording the command list ID and the command line can be included in the title resumption information register 420 of FIG. 4. Accordingly, when resuming the title, the command processor 451 can refer to the registers in the title resumption information register 420, which store the command list ID and the command line, in order to restore the command list ID and the command line which has been executed in the title that is to be resumed.

Each register in the playback status register 372 can change a value stored in the corresponding register only by a certain command. For example, a register storing PlayList information can change its value only by a Play PlayList command and can transfer the PlayList information in the title resumption information register 420 to a PlayList information register in the title playback information register 410 only by a resume command. Also, the title resumption information register 420 can store only the title playback information that is being currently reproduced by the apparatus 300 when commands, such as Call Title, etc., are being executed. However, various title transferences and resumptions are possible as compared to a conventional simple title resumption by allowing an arbitrary change of a value stored in the title resumption information register 420.

FIG. 6 is a diagram illustrating an example of transferring and resuming playback of a title when a value of a title resumption information register can be changed by a playback control command according to an embodiment of the present invention. Playback is performed in the order of a Title #1 -->Call Title #2 604 -->Jump Title #3 -->Resume (the Title #1). When changing of a value in the title resumption information register 420 using a playback control command is not allowed, information in the title resumption information register for resuming at the Title #1 is deleted while executing the Jump Title #3 after reproducing the Title #2. Accordingly, after reproducing Title #3, resuming at a location in the Title #1 where the playback had stopped is not possible. However, when changing of a value in the title resumption information register 420 using the playback control command is allowed, the value in the title resumption information register 420, recorded with title resumption information for resuming the Title #1, is temporarily recorded in a general purpose register 371 while executing a Command List #2 605 of the Title #2. After reproducing Title #2, Jump Title #3 is executed in order to reproduce an AV stream #3 611 of a PlayList #4 610 by Play PlayList #4 610. Then, the title resumption information for resuming the Title #1, which is temporarily recorded in the general purpose register 371, is recorded back to the title resumption information register 420. Accordingly, by executing a command, i.e., Resume, it is possible to resume at the Title #1.

Hereinafter, executing command lists illustrated in FIG. 6 will be described in detail. Title #1 includes a Command List #1 601, wherein the command processor 351 of FIG. 3 executes a first command, i.e. Play PlayList #1 602, in the Command List #1 601 in order to reproduce PlayList #1 601. When Call Title #2 604 is input from a user while reproducing an AV stream #0 603 included in the PlayList #1 602, the command processor 351 records in the title resumption information register 420 title playback information of the Title #1 being reproduced, stops reproducing an image, and transfers to the Title #2. When the Command List #2 605 of the Title #2 is executed in order to reproduce the Title #2, the command processor 351 executes Save Resume Info, a resumption information store command, as a first command of the Command List #2 605. The command processor 351 temporarily stores the value of the title resumption information register 420, which contains the title resumption information of Title #1, in the general purpose register 371 using Save Resume Info. Then, the command processor 351 executes a second command, i.e. Play PlayList #3 606, in order to reproduce an AV stream #2 607 included in the PlayList #3 606. While reproducing the AV stream #2 607, Jump Title #3 is executed, and thus the AV stream #3 611 of the PlayList #4 610 is reproduced by a first command, i.e., Play PlayList #4 610, of a Command List #3 609 included in the Title #3. After completing the reproduction of the AV stream #3 611, the command processor 351 records the title resumption information of the Title #1, which is temporarily stored in the general purpose register 371, back in the title resumption information register 420 by a resumption information restore command, i.e., Restore Resume Info, as a second command of the Command List #3 609. Accordingly, by executing a third command, i.e., Resume, it is possible to resume at the Title #1.

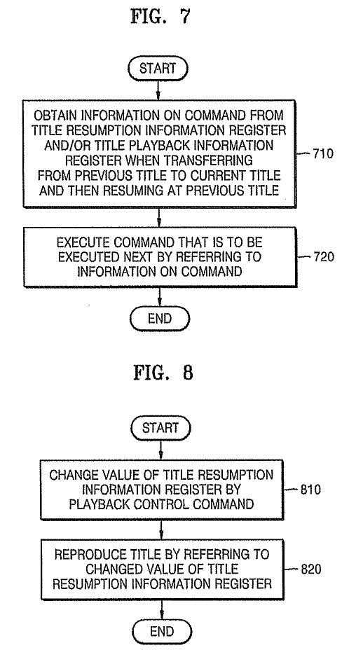

FIG. 7 is a flowchart of controlling reproduction of AV data by referring to information about a command when resuming a title according to an embodiment of the present invention. When transferring from a previous title to a current title and then resuming at the previous title, information about a command which is to be executed in the previous title is obtained from the title resumption information register 420 and/or the title playback information register 410 in operation 710. A method of obtaining the information includes preparing a register in the title resumption information register 420 to store the information about the command to be executed in the previous title; recording the information about the command in the title resumption information register 420 when transferring from the previous title to the current title; and obtaining the information about the command recorded in the title resumption information register 420 when resuming at the previous title after the current title. Another method of obtaining the information includes preparing a register in both the title playback information register 410 and the title resumption information register 420 to store the information about the command to be executed in the previous title; and transferring and recording the information about the command stored in the title resumption information register in the title playback information register 410 when resuming at the previous title after the current title. Once the information is obtained, the command in the previous title is executed in operation 720 by referring to the information about the command to be executed in the previous title, which is stored in either the title playback information register 410 or the title resumption information register 420.

FIG. 8 is a flowchart of controlling reproduction by changing a value of the title resumption information register 420 according to an embodiment of the present invention. A value of the title resumption information register 420 is changed by a playback control command in operation 810. Transference or resumption of the title is executed by referring to the changed value of the title resumption information register 420 in operation 820.

Aspects of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to aspects of the present invention, by adding registers for each recording a command list ID and a command line in a title playback information register and/or a title resumption information register, exact information about a command which has to be executed after transferring and resuming the title can be restored. Also, by allowing a change of a value in the title resumption information register using a playback control command, transference and resumption between a plurality of titles can be efficiently controlled.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of controlling reproduction of a title recorded in an information recording medium and comprising AV data, the method comprising:
controlling playback of a previous title, which has been reproduced before a current title currently being reproduced, by referring to information about a command, which is to be executed after resuming at the previous title, when resuming at the previous title.

2. The method of claim 1, wherein the information about the command comprises identifier information of a command list which should be executed for the previous title.

3. The method of claim 2, wherein the information about the command further comprises location information of a command, which has been most recently executed from the command list, or location information of a command, which is to be executed next.

4. The method of claim 1, further comprising:
recording the information about the command in a title playback information register when reproducing the previous title.

5. The method of claim 4, further comprising:
recording in a title resumption information register the information about the command recorded in the title playback information register when transferring from the previous title to the current title.

6. The method of claim 5, further comprising:
recording in the title playback information register the information about the command recorded in the title resumption information register, when resuming at the previous title after the current title has completed.

7. The method of claim 1, further comprising:
recording the information about the command in a title resumption information register when transferring from the previous title to the current title; and
executing a command for the previous title by referring to the information about the command recorded in the title resumption information register, when resuming at the previous title after the current title.

8. A method of controlling reproduction of a title recorded in an information recording medium and comprising AV data, the method comprising:
arbitrarily changing title resumption information stored in a title resumption information register using a playback control command; and
controlling playback of the title by referring to the changed title resumption information.

9. The method of claim 8, wherein the arbitrarily changing comprises recording the title resumption information, stored in the title resumption information register, in a general purpose register using a first playback control command.

10. The method of claim 8, wherein the arbitrarily changing comprises recording the title resumption information, stored in the general purpose register, in the title resumption information register using a second playback control command.

11. The method of claim 8, wherein the arbitrarily changing comprises:
recording title playback information stored in a title playback information register as the title resumption information of the title resumption information register using a title call command;
recording the title resumption information, stored in the title resumption information register, in a general purpose register using a resume information store command;
deleting the title resumption information, stored in the title resumption information register, using a title jump command; and
recording the title resumption information, stored in the general purpose register, in the title resumption information register using a resume information restore command.

12. An apparatus for controlling reproduction of a title recorded in an information recording medium and comprising AV data, the apparatus comprising:
a reader to read the title from the information recording medium; and
a playback controller to control playback of a previous title by referring to information about a command which is to be executed after resuming the previous title, when resuming the previous title;
wherein the previous title has been reproduced before a current title currently being reproduced.

13. The apparatus of claim 12, wherein the information about the command comprises identifier information of a command list which should be executed for the previous title.

14. The apparatus of claim 13, wherein the information about the command further comprises location information of a command that is the latest executed from the command list, or location information of a command that is to be executed next.

15. The apparatus of claim 12, further comprising:
a title playback information register to store title playback information;
wherein the playback controller records the information about the command in the title playback information register when reproducing the previous title.

16. The apparatus of claim 15, further comprising a title resumption information register which stores title resumption information into which the playback controller records the information about the command recorded in the title playback information register when transferring from the previous title to the current title.

17. The apparatus of claim 16, wherein the playback controller records the information about the command, recorded in the title resumption information register, in the title playback information register when resuming at the previous title after the current title has completed.

18. The apparatus of claim 12, wherein:
the playback controller records the information about the command in the title resumption information register when transferring from the previous title to the current title by recalling the information about the command for title resumption; and
the playback controller reproduces the previous title by referring to the information about the command recorded in the title resumption information register, when resuming at the previous title after the current title.

19. An apparatus for controlling reproduction of a title recorded in an information recording medium and comprising AV data, the apparatus comprising:
a title resumption information register to store title resumption information is used when resuming at a previous title after a current title; and
a playback controller, to arbitrarily change the title resumption information stored in the title resumption information register using a playback control command and to control playback of the title by referring to the changed title resumption information.

20. The apparatus of claim 19, wherein the playback controller records the title resumption information stored in the title resumption information register in a general purpose register using a first playback control command.

21. The apparatus of claim 19, wherein the playback controller records the title resumption information stored in a general purpose register in the title resumption information register using a second playback control command.

22. The apparatus of claim 19, wherein:
the playback controller records title playback information of a title playback information register as the title resumption information of the title resumption information register using a title call command; records the title resumption information stored in the title resumption information register in a general purpose register using a resume information store command; deletes the title resumption information stored in the title resumption information register using a title jump command; and records the title resumption information stored in the general purpose register in the title resumption information register using a resume information restore command.

23. An information recording medium for an apparatus to control reproduction of AV data, the information recording medium comprising:
a title comprising the AV data; and
a playback control command to control an arbitrary change of title resumption information, stored in a title resumption information register, which is used when resuming at a previous title after a current title that is currently being reproduced has completed.

24. The information recording medium of claim 23, wherein the playback control command comprises a first playback control command to command the title resumption information, stored in the title resumption information register, to be recorded in a general purpose register.

25. The information recording medium of claim 23, wherein the playback control command comprises a second playback control command to command the title resumption information, stored in a general purpose register, to be recorded in the title resumption information register.

26. The information recording medium of claim 23, wherein the playback control command comprises instructions for:
recording title playback information stored in a title playback information register as the title resumption information of the title resumption information register using a title call command;
recording the title resumption information, stored in the title resumption information register, in a general purpose register using a resume information store command;
deleting the title resumption information, stored in the title resumption information register, using a title jump command; and
recording the title resumption information, stored in the general purpose register, in the title resumption information register using a resume information restore command.

27. A method of controlling reproduction of a title comprising AV data and a plurality of commands, the method comprising:
executing a first command in the title;
transferring to a second title;
automatically resuming execution of the first command; and
executing a second command in the title.

28. The apparatus according to claim 19, further comprising:
a general purpose register to store title resumption information recorded by the playback controller.

29. The apparatus according to claim 19, further comprising:
a title playback information register to store title playback information recorded by the playback controller.
